(19) United States
(12) Patent Application Publication
(10) Pub. No.: US 2013/0017750 A1
(43) Pub. Date: Jan. 17, 2013

(54) METHOD AND APPARATUS FOR MANUFACTURING LIQUID CRYSTAL DISPLAY PANEL

(71) Applicants: Jo-shan Wu, Shenzhen (CN); Hungjui Chen, Shenzhen (CN)

(72) Inventors: Jo-shan Wu, Shenzhen (CN); Hungjui Chen, Shenzhen (CN)

(73) Assignee: SHENZHEN CHINA STAR OPTOELECTRONICS TECHNOLOGY CO., LTD., Shenzhen (CN)

(21) Appl. No.: 13/379,218

(22) PCT Filed: Sep. 22, 2011
(86) PCT No.: PCT/CN2011/079988

§ 371 Date: Dec. 19, 2011

(30) Foreign Application Priority Data
Jul. 11, 2011 (CN) 201110192809.5

(51) Int. Cl. H01J 9/24

(52) U.S. Cl. 445/24

(57) ABSTRACT

The embodiment of the present invention provides a method and an apparatus for manufacturing a liquid crystal display (LCD) panel. The method comprises: alternately processing a first substrate and a second substrate on a production line for achieving an array process of the first substrate and the second substrate, coating a sealant, coating a silver adhesive and dispensing a liquid crystal (LC) mixed with monomers, wherein the first substrate is a thin film transistor (TFT) substrate, and the second substrate is a color filter (CF) substrate; assembling the first substrate and the second substrate as a large panel and curing the sealant there between; applying a voltage and irradiating an ultraviolet light to the large panel, so as to allow LC molecules in the large panel to have a pre-tile angle; and cutting the large panel according to a predetermined size, thereby achieving the LCD panel. The method and the apparatus of the embodiment of the present invention for manufacturing the LCD panel can achieve the production of the LCD panel on the single production line, thus preventing idle times on the production line and raising the production efficiency. The occupied area of the equipments for manufacturing the LCD panel can be decreased, and the production cost of the LCD panel can be reduced.

This application claims priority of a Chinese patent application, whose application number is 201110192809.5 and whose title is method and apparatus for manufacturing liquid crystal display panel”, submitted to the Patent Office of the People's Republic of China on Jul. 11, 2011, and hereby incorporated by reference in its entirety.

### FIELD OF THE INVENTION

The present invention relates to a field of manufacturing a liquid crystal display (LCD) panel, and more particularly to a method and an apparatus for manufacturing an LCD panel.

### BACKGROUND OF THE INVENTION

LCD is a planar and thin display apparatus. The LCD is a display using a liquid crystal (LC) material. The LC is an organic compound between a solid state and a liquid state. The LC molecules can be rotated under the action of an electric field for altering a transmittance, thereby achieving a multiple gray displaying. By means of an arrangement of the LC molecules, a variation of light beams that pass through the LC molecules can be affected. The variation of the light beams can be performed as lighting or shading by polarizers. The LCD controls the lighting or shading of the light beams by means of controlling the electric field, hence achieving an object of displaying images.

The LCD has low power consumption and is widely applied in electrical products, and thus is very popular for market. Therefore, it is desirable that the production efficiency of the LCD can be increased. An LCD panel is an important component of the LCD, and the production efficiency the panel directly affects the production efficiency of the LCD.

At present, a main process for manufacturing the LCD panel is shown in FIG. 1. Thin film transistor (TFT) substrates and color filter (CF) substrates are fabricated on two production lines, respectively. The process for manufacturing the LCD panel comprises alignment, washing, sealant coating, silver coating, LC dispensation and the like. After the above-mentioned steps, the TFT substrate and the CF substrate are sequentially assembled, cured and cut for final inspection.

The production time of the LCD panel can be reduced by means of the above-mentioned process for manufacturing the same. However, the production times of the TFT substrate and the CF substrate are different, and there are some idle times in the two production lines, thus reducing the production efficiency of the production lines for the LCD panel. Specially, when there is some problem with one production line, another production line has to be stopped, hence greatly deteriorating the production efficiency. At the same time, the production lines for the LCD panel have a high equipment cost and a large occupied area, and thus the process using the two production lines for manufacturing the LCD panel has a very high production cost.

### SUMMARY OF THE INVENTION

The technical problem solved by the embodiment of the present invention is to provide a method and an apparatus for manufacturing the LCD panel for preventing idle times on the production line and raising the production efficiency. At the same time, by means of the method and the apparatus provided by the embodiment of the present invention for manufacturing the LCD panel, the occupied area of the equipments for manufacturing the LCD panel can be decreased, and the production cost of the LCD panel can be reduced.

To solve the above-mentioned technical problem, the embodiment of the present invention provides a method for manufacturing the LCD panel, comprising: alternately processing a first substrate and a second substrate on a production line for achieving an array process of the first substrate and the second substrate, coating a sealant, coating a silver adhesive and dispensing a liquid crystal (LC) mixed with monomers, wherein the first substrate is a TFT substrate, and the second substrate is a CF substrate; assembling the first substrate and the second substrate as a large panel and curing the sealant there between; applying a voltage and irradiating an ultraviolet light to the large panel, so as to allow LC molecules in the large panel to have a pre-tile angle; and cutting the large panel according to a predetermined size, thereby achieving the LCD panel.

In this case, the array process comprises: arranging a plurality of gate lines with a specific interval and a plurality of data lines with a specific interval, wherein the gate lines are vertical to the data lines, and a minimum rectangular region, which is surrounded by the gate lines and the data lines, comprises a TFT and a pixel electrode; and coating a black matrix, a color filter layer and a common electrode on the second substrate.

In this case, one or two of three steps of coating the sealant, coating the silver adhesive and dispensing the LC mixed with monomers are executed on the first substrate by the production line, and the rest of the three steps is executed on the second substrate by the production line, and a sequence for alternately executing the three steps on the first substrate and the second substrate by means of the production line is arbitrary.

In this case, the method further comprises: after applying a voltage and irradiating an ultraviolet light to the large panel to allow the LC molecules in the large panel to have the pre-tile angle, irradiating the ultraviolet light to the large panel again, so as to allow the residual monomers of the LC molecules in the large panel to react completely.

In this case, the step of cutting the large panel according to a predetermined size for achieving the LCD panel comprises: bonding polarizers on an LC panel and pressing the LC panel to remove bubbles, thereby achieving the LCD panel.

Correspondingly, the embodiment of the present invention further provides an apparatus for manufacturing the LCD panel, comprising: a production line; a production line control module configured to control the production line to alternately process the first substrate and the second substrate for achieving an array process of the first substrate and the second substrate, coating a sealant, coating a silver adhesive and dispensing an LC mixed with monomers, wherein the first substrate is a TFT substrate, and the second substrate is a CF substrate; a substrate assembling module configured to assemble the first substrate and the second substrate as a large pane, and to cure the sealant there between; an alignment control module configured to apply the voltage and irradiate the UV light to the large pane, so as to allow LC molecules in the large panel to have a pre-tile angle; and a cutting module configured to cut the large panel according to a predetermined size, thereby achieving the LCD panel.

In this case, the production line comprises: a substrate washing unit controlled by the production line control module, so as to wash the first substrate and the second substrate; an alignment film coating unit controlled by the production line control module, so as to coat alignment films on the first substrate and the second substrate; an alignment films curing unit controlled by the production line control module, so as to cure the alignment films on the first substrate and the second substrate; a sealant coating unit controlled by the production line control module, so as to coat the sealant at the fringe of the first substrate or the second substrate; a silver adhesive coating unit controlled by the production line control module, so as to dispense the silver adhesive on the first substrate or the second substrate; and an LC dispensing unit controlled by the production line control module, so as to dispense the LC mixed with the monomers on the first substrate or the second substrate; wherein the an arrangement sequence of the sealant coating unit, the silver adhesive coating unit and the LC dispensing unit on the production line is arbitrary.

In this case, the alignment control module comprises: a voltage applying unit configured to apply a specific voltage to the large panel for adjusting the arrangement of the LC molecules in the large panel; a curing unit configured to irradiate the ultraviolet rays to the large panel when voltage applying unit applies the voltage to the large panel, so as to allow the monomers mixed in the LC of the large panel to orient the LC molecules.

In this case, the curing unit is further configured to irradiate the ultraviolet rays to the large panel again, so as to allow the residual monomers to react completely.

In this case, the cutting module comprises: an LC panel cutting unit configured to cut the large panel according to the predetermined size for forming an LC panel; and a polarizer bonding unit configured to bond the polarizers to the LC panel and press the LC panel to remove bubbles, thereby achieving the LCD panel.

The method and the apparatus provided by the embodiment of the present invention for manufacturing the LCD panel can achieve the production of the LCD panel on a single production line, thus preventing idle times on the production line and raising the production efficiency. At the same time, the occupied area of the equipments for manufacturing the LCD panel can be decreased, and the production cost of the LCD panel can be reduced.

### DESCRIPTION OF THE DRAWINGS

The structure and the technical means adopted by the present invention to achieve the above and other objects can be best understood by referring to the following detailed description of the preferred embodiments and the accompanying drawings. Obviously, the following drawings are merely shown for some embodiments of the present invention. For a person skilled in the art, other drawings can be obtained according these drawings without creative labor.

FIG. 1 is a schematic diagram showing a conventional process for manufacturing a LCD panel;

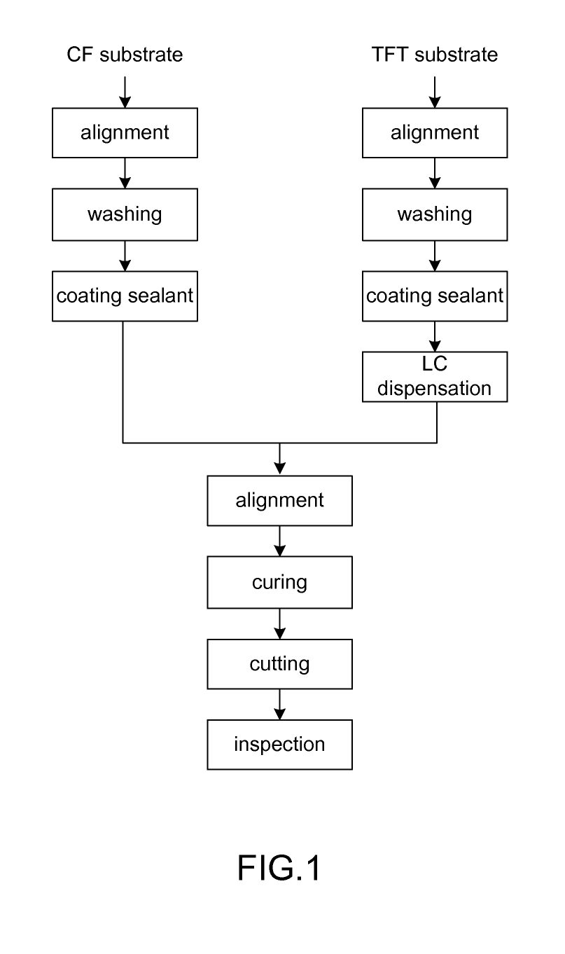

FIG. 2 is a flow diagram showing a method for manufacturing the LCD panel according to a first embodiment of the present invention;

FIG. 3 is a flow diagram showing a method for manufacturing the LCD panel according to a second embodiment of the present invention;

FIG. 4 is a structural diagram showing an apparatus for manufacturing the LCD panel according to the first embodiment of the present invention;

FIG. 5 is a structural diagram showing an apparatus for manufacturing the LCD panel according to the second embodiment of the present invention.

### DETAILED DESCRIPTION OF THE PREFERRED EMBODIMENTS

The embodiments of the present invention provide a method and an apparatus for manufacturing an LCD panel which can achieve the production of the LCD panel on a single production line, thus preventing idle times on the production line and raising the production efficiency. At the same time, the occupied area of the equipments for manufacturing the LCD panel can be decreased, and the production cost of the LCD panel can be reduced.

The technical solutions of the present invention can be best understood by referring to the following detailed description of the preferred embodiments and the accompanying drawings. Obviously, the following detailed description of the embodiment is only a portion of the embodiments of the present invention, but not the all embodiments. Based on the embodiments of the present invention, other changes and modifications to the described embodiments by a person skilled in the art without creative labor belong to the scope of the invention.

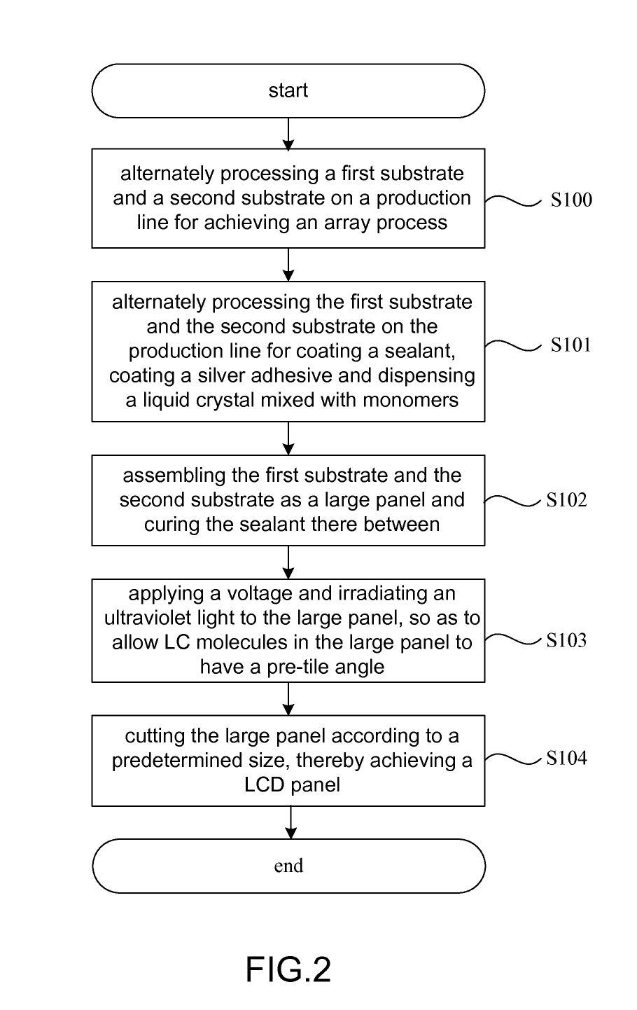

Referring to FIG. 2, a flow diagram showing a method for manufacturing the LCD panel according to a first embodiment of the present invention is illustrated. In the embodiments of the present invention, a first substrate is realized as a TFT substrate, and a second substrate is realized as a CF substrate. The method for manufacturing the LCD panel is shown in FIG. 2.

In the step S100, the first substrate and the second substrate are alternately processed on the single production line for achieving an array process of the first substrate and the second substrate.

In the step S101, the first substrate and the second substrate are alternately processed on the single production line for coating a sealant, coating a silver adhesive and dispensing a liquid crystal (LC) mixed with monomers.

In the step S102, the first substrate and the second substrate are assembled as a large pane, and then the sealant there between are cured.

In the step S103, a voltage is applied to the large pane, and an ultraviolet light is irradiated to the large panel, so as to allow LC molecules in the large panel to have a pre-tile angle.

In the step S104, the large panel is cut according to a predetermined size, thereby achieving the LCD panel.

The manufacturing method provided by the embodiments of the present invention can achieve the production of the LCD panel on the single production line, thus preventing idle times on the production line and raising the production efficiency. At the same time, the occupied area of the equipments for manufacturing the LCD panel can be decreased, and the production cost of the LCD panel can be reduced.

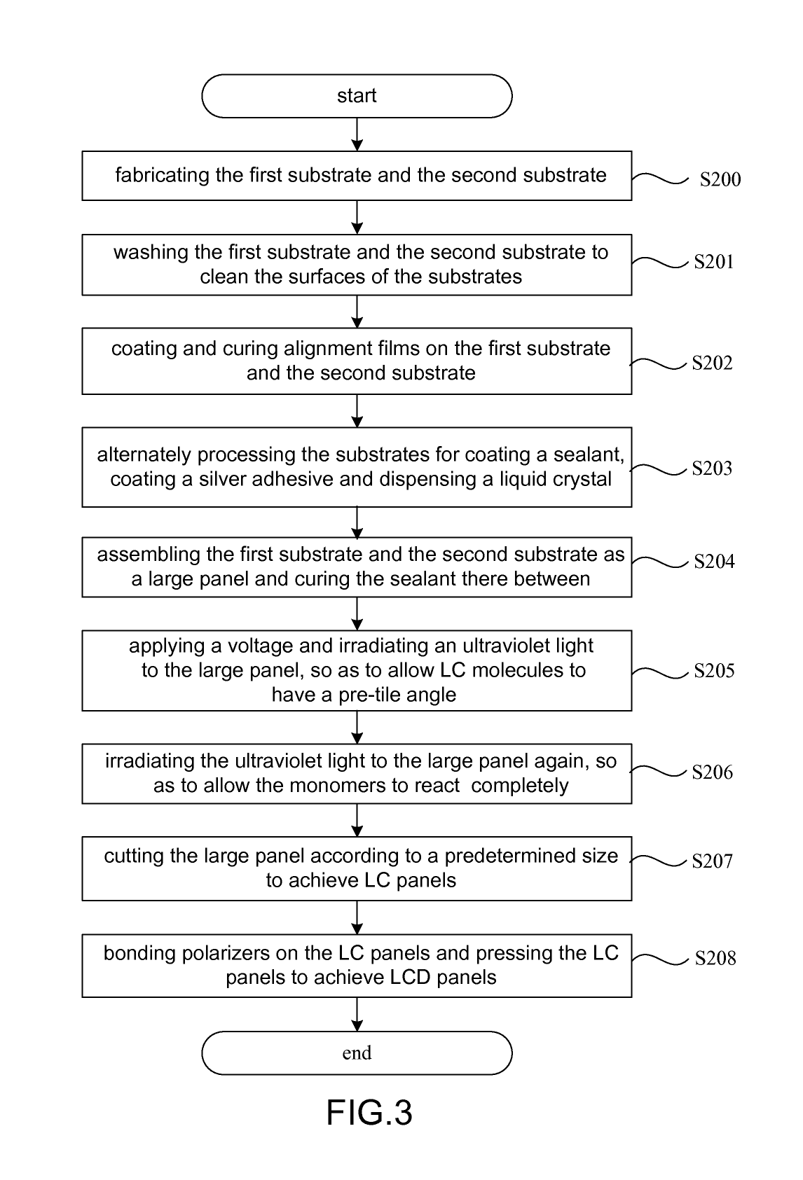

Referring to FIG. 3, a flow diagram showing a method for manufacturing the LCD panel according to a second embodiment of the present invention is illustrated. In comparison with the above-mentioned embodiment, as shown in FIG. 3, the process of the method for manufacturing the LCD panel is described more detailedly in this embodiment.

In the step S200, the first substrate and the second substrate are manufactured. The first substrate includes a plurality of gate lines distanced from each other and a plurality of data lines distanced from each other, and the gate lines are vertical to the data lines. A minimum rectangular region, which is surrounded by the gate lines and the data lines, is defined as a pixel region, wherein each pixel region comprises a TFT and a pixel electrode. The second substrate includes a black matrix, a color filter layer and a common electrode. The present invention mainly aims to alternately process the first substrate and the second substrate on the single production line.

In the step S201, the first substrate and the second substrate are washed for cleaning the surfaces of the substrates. The washing method may be executed by scrubbing, such as using cylinder brushes, wind knife and radiation.

In the step S202, alignment films are uniformly coated on the first substrate and the second substrate, respectively, and are cured. In this embodiment of the present invention, the alignment films may be PI alignment films. The composition of the PI alignment films may be polyimide (PI) with ultraviolet (UV) reactive groups and a solvent. The PI films can determine the orientation of the LC by means of irradiating light, and thus are good for the production efficiency and operation.

In the step S203, the first substrate and the second substrate are alternately processed for coating the sealant, coating the silver adhesive and dispensing the LC mixed with monomers. More specifically, after the alignment step, the first substrate and the second substrate are washed, and then the sealant is coated on the first substrate or the second substrate for bonding the first substrate and the second substrate in the next step to form a sealed LC cell, preventing the LC from leaking out. Subsequently, the silver adhesive is coated (or dispensed) on the first substrate or the second substrate, so as to allow the first substrate to be connected to the common electrode. Subsequently, the LC mixed with the monomers is dispensed on the first substrate or the second substrate.

Furthermore, in this step, the sequence of the three steps for coating the sealant, coating the silver adhesive and dispensing the LC mixed with monomers on the production line can be arbitrary. For example, on the production line, the silver adhesive can be first coated, and then the sealant can be coated, and finally the LC mixed with monomers is dispensed. Alternatively, the silver adhesive can be first coated, and the LC mixed with monomers is dispensed, and finally the sealant can be coated. Therefore, the sequence of the three steps can be arbitrary.

At the same time, when executing any step of the steps S204 to S206 on the production line, the first substrate or the second substrate can be processed, but the two substrates are not processed in the same step simultaneously. For example, the production line can coat the sealant on the first substrate or the second substrate, but will not coat the sealant on the first substrate and the second substrate simultaneously. Alternatively, the production line can dispense the LC mixed with monomers on the first substrate or the second substrate, but will not dispense the LC mixed with monomers on the first substrate and the second substrate simultaneously.

In the step S204, the first substrate and the second substrate are assembled as the large pane. More specifically, after dispensing the LC and assembling, the sealant of the LC cell is cured by a UV radiation. In the UV curing step, the sealant has a sealing compound. After irradiating the UV light to the sealant, the sealant can absorb the high intensity UV radiation and has a chemical reaction. The sealing compound of the sealant will react to generate free radicals or ions. The free radicals or ions have a crosslinking reaction with double bond of pre-polymer or unsaturated monomers to form monomer groups, resulting in polymerization, crosslinking and graft reaction, thereby allowing the sealant to transform from the liquid state to the solid state.

In the step S205, a voltage is applied to the large pane, and an ultraviolet light is irradiated to the large panel for adjusting the arrangement of the LC molecules in the large panel, so as to allow the monomers mixed in the LC of the large panel to orient the LC molecules.

In the step S206, the ultraviolet light is irradiated to the large panel again, so as to allow the monomers mixed in the LC to react completely and have the pre-tile angle. After the voltage applying and UV light irradiating in the step S205, there may be some monomers which do not react completely in the LC of the large panel, and thus the ultraviolet light can be irradiated to the large panel again, so as to allow the residual monomers to react completely.

Preferably, before irradiating the UV rays to the large panel, it may be inspected whether the LC molecules in the large panel have the pre-tile angle.

In the step S207, the large panel is cut according to a predetermined size, thereby achieving LC panel.

In the step S208, polarizers are bonded to the LC panel, and the LC panel is pressed to remove bubbles, thereby achieving the LCD panel.

The method for manufacturing the LCD panel provided by the embodiment of the present invention can achieve the production of the LCD panel on a single production line, thus preventing idle times on the production line and raising the production efficiency. At the same time, the occupied area of the equipments for manufacturing the LCD panel can be decreased, and the production cost of the LCD panel can be reduced.

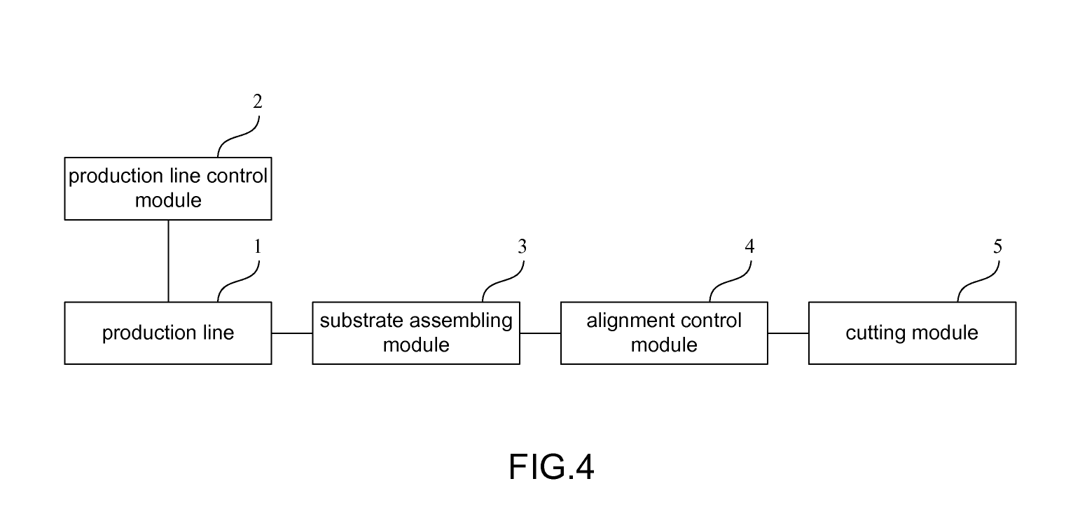

Referring to FIG. 4, a structural diagram showing an apparatus for manufacturing the LCD panel according to the first embodiment of the present invention is illustrated. The apparatus provided by the embodiment can execute the method for manufacturing the LCD panel as shown in FIG. 2. The apparatus for manufacturing the LCD panel is shown in FIG. 4, comprises a production line 1, a production line control module 2, a substrate assembling module 3, an alignment control module 4 and a cutting module 5. The production line 1 is configured to process the first substrate and the second substrate. The production line control module 2 is configured to control the production line 1 to alternately process the first substrate and the second substrate for achieving an array process of the first substrate and the second substrate, coating the sealant/the silver adhesive and dispensing the LC mixed with monomers. The substrate assembling module 3 is configured to assemble the first substrate and the second substrate as the large pane, and to cure the sealant there between. The alignment control module 4 is configured to apply the voltage and irradiate the UV light to the large pane, so as to allow the LC molecules in the large panel to have a pre-tile angle. The cutting module 5 is configured to cut the large panel according to the predetermined size, thereby achieving the LCD panel.

The apparatus for manufacturing the LCD panel provided by the embodiment of the present invention can achieve the production of the LCD panel on a single production line, thus preventing idle times on the production line and raising the production efficiency. At the same time, the occupied area of the equipments for manufacturing the LCD panel can be decreased, and the production cost of the LCD panel can be reduced.

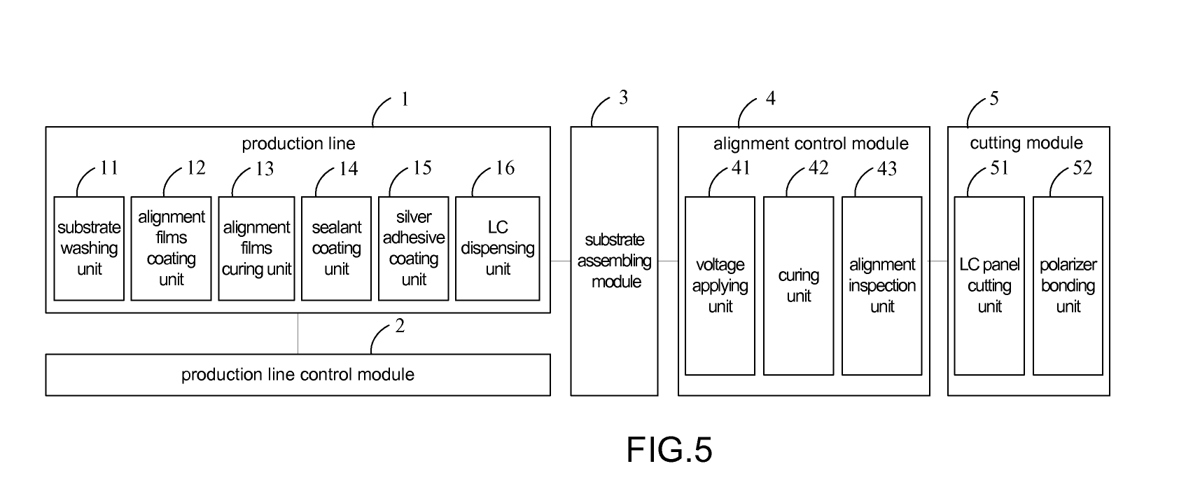

Referring to FIG. 5, a structural diagram showing an apparatus for manufacturing the LCD panel according to the second embodiment of the present invention is illustrated. In comparison with the above-mentioned embodiment, the apparatus of the method for manufacturing the LCD panel is described more detailedly in this embodiment. At the same time, the apparatus provided by the embodiment can execute the method for manufacturing the LCD panel as shown in FIG. 3. The apparatus for manufacturing the LCD panel is shown in FIG. 5, comprises a production line 1, a production line control module 2, a substrate assembling module 3, a alignment control module 4 and a cutting module 5.

This embodiment of the present invention aims to alternately process the first substrate and the second substrate on the single production line 1. More specifically, the production line 1 comprises the following units.

A substrate washing unit 11 of the production line 1 is controlled by the production line control module 2, so as to wash the first substrate and the second substrate. More specifically, the substrate washing unit 11 is configured to wash the fabricated first and the second substrates for cleaning the surfaces of the substrates. The washing method of the substrate washing unit 11 may be executed by scrubbing, such as using cylinder brushes, wind knife and radiation.

Moreover, the fabricated first substrate is realized as the first substrate including the plurality of gate lines with a specific interval and the plurality of data lines with a specific interval, and the gate lines are vertical to the data lines. A minimum rectangular region, which is surrounded by the gate lines and the data lines, is defined as a pixel region, wherein each pixel region comprises a TFT and a pixel electrode. The fabricated second substrate includes a black matrix, a color filter layer and a common electrode.

An alignment film coating unit 12 of the production line 1 is controlled by the production line control module 2, so as to uniformly coat the alignment films on the first substrate and the second substrate. In this embodiment of the present invention, the alignment films may be PI alignment films. The composition of the PI alignment films may be polyimide (PI) with UV reactive groups and a solvent. The PI films can determine the orientation of the LC by means of irradiating light, and thus are good for the production efficiency and operation.

An alignment films curing unit 13 of the production line 1 is controlled by the production line control module 2, so as to cure the alignment films on the first substrate and the second substrate. In general, the alignment films on the first substrate and the second substrate are cured at a high temperature.

A sealant coating unit 14 of the production line 1 is controlled by the production line control module 2, so as to coat the sealant at the fringe of the first substrate or the second substrate for bonding the first substrate or the second substrate in the next step, thereby forming the sealed LC cell and preventing the LC from leaking out.

A silver adhesive coating unit 15 of the production line 1 is controlled by the production line control module 2, so as to coat (dispense) the silver adhesive on the first substrate or the second substrate, allowing the first substrate to be connected to the common electrode.

An LC dispensing unit 16 of the production line 1 is controlled by the production line control module 2, so as to dispense the LC mixed with the monomers on the first substrate or the second substrate.

It should be explained that an arrangement sequence of the sealant coating unit 14, the silver adhesive coating unit 15 and the LC dispensing unit 16 on the production line 1 can be arbitrary. For example, on the production line 1, the silver adhesive coating unit 15 is first disposed, and the sealant coating unit 14 is disposed downstream of the silver adhesive coating unit 15, and the LC dispensing unit 16 is disposed downstream of the sealant coating unit 14. In the process of manufacturing the LCD panel, the silver adhesive can be first coated on the substrate, and then the sealant can be coated thereon, and finally the LC is dispensed thereon. Alternatively, the silver adhesive coating unit 15 is first disposed, and the LC dispensing unit 16 is disposed downstream of the silver adhesive coating unit 15, and the sealant coating unit 14 is disposed downstream of the LC dispensing unit 16. In the process of manufacturing the LCD panel, the silver adhesive can be first coated on the substrate, and then the LC mixed with the monomers can be dispensed thereon, and finally the sealant can be coated thereon. That is, the sequence of the sealant coating unit 14, the silver adhesive coating unit 15 and the LC dispensing unit 16 can be arbitrary.

At the same time, the sealant coating unit 14, the silver adhesive coating unit 15 and the LC dispensing unit 16 of the production line can alternately process the first substrate or the second substrate, but the two substrates are not processed in the same step simultaneously. For example, the sealant coating unit 14 can coat the sealant on the first substrate or the second substrate, but will not coat the sealant on the first substrate and the second substrate simultaneously. Alternatively, the LC dispensing unit 16 can dispense the LC mixed with monomers on the first substrate or the second substrate, but will not dispense the LC mixed with monomers on the first substrate and the second substrate simultaneously.

The production line control module 2 is configured to control the units of the production line 1 to alternately process the first substrate and the second substrate for achieving an array process of the first substrate and the second substrate, coating the sealant/the silver adhesive, dispensing the LC mixed with monomers and the like.

The substrate assembling module 3 is configured to assemble the first substrate and the second substrate as the large pane, and to cure the sealant there between. More specifically, after assembling the first substrate and the second substrate as the large pane by means of the substrate assembling module 3, the sealant of the large pane is cured by a UV radiation. In the UV curing step, the sealant has a sealing compound. After irradiating the UV light to the sealant, the sealant can absorb the high intensity UV radiation and has a chemical reaction. The sealing compound of the sealant will react to generate free radicals or ions. The free radicals or ions have a crosslinking reaction with double bond of pre-polymer or unsaturated monomers to form monomer groups, resulting in polymerization, crosslinking and graft reaction, thereby allowing the sealant to transform from the liquid state to the solid state.

The alignment control module 4 is configured to apply the voltage and irradiate the UV light to the large panel for adjusting the arrangement of the LC molecules in the large panel, so as to allow the monomers mixed in the LC of the large panel to orient the LC molecules. Specifically, the alignment control module 4 comprises a voltage applying unit 41 and a curing unit 42. The voltage applying unit 41 is configured to apply a specific voltage to the large panel for adjusting the arrangement of the LC molecules in the large panel. The curing unit 42 is configured to irradiate the UV rays to the large panel when voltage applying unit 41 applies the voltage to the large panel, so as to allow the monomers mixed in the LC of the large panel to orient the LC molecules. Furthermore, after the voltage applying and UV light irradiating, there may be some monomers which do not react completely in the LC of the large panel, and thus the ultraviolet light can be irradiated to the large panel again, so as to allow the residual monomers to react completely and have the pre-tile angle.

Preferably, the alignment control module 4 further comprises an alignment inspection unit 43 configured to inspect whether the LC molecules in the large panel, which is processed by the voltage applying unit 41 and the curing unit 42, have the pre-tile angle.

The cutting module 5 is configured to cut the large panel according to the predetermined size, thereby achieving the LCD panel. More specifically, the cutting module 5 comprises a LC panel cutting unit 51 and a polarizer bonding unit 52. The LC panel cutting unit 51 is configured to cut the large panel according to the predetermined size for forming the LC panel. The polarizer bonding unit 52 is configured to bond the polarizers to the LC panel and press the LC panel to remove bubbles, thereby achieving the LCD panel.

The apparatus for manufacturing the LCD panel provided by the embodiment of the present invention can achieve the production of the LCD panel on the single production line, thus preventing idle times on the production line and raising the production efficiency. At the same time, the occupied area of the equipments for manufacturing the LCD panel can be decreased, and the production cost of the LCD panel can be reduced. Moreover, in this manufacturing apparatus, after assembling the substrates as the large panel, the voltage is applied to the large pane, and the ultraviolet light is irradiated to the large panel, so as to allow the LC molecules in the large panel to have the predetermined alignment, and to enhance a bonding between the alignment film and the substrates.

A person skilled in the art would understand that partial or all the steps in the method of the above-mentioned embodiments can be executed by related hardware which is commanded by a computer program. The computer program can be stored in a computer readable storage medium for executing the steps in the above-mentioned method of the embodiments, wherein the storage medium may be a hard disk, a compact disk (CD), a read-only memory (ROM), a random access memory (RAM) and the like.

The present invention has been described with preferred embodiments thereof and it is understood that many changes and modifications to the described embodiments can be carried out without departing from the scope and the spirit of the invention that is intended to be limited only by the appended claims.

1. A method for manufacturing a liquid crystal display (LCD) panel, characterized in that: the method comprises:
alternately processing a first substrate and a second substrate on a production line for achieving an array process of the first substrate and the second substrate, coating a sealant, coating a silver adhesive and dispensing a liquid crystal (LC) mixed with monomers, wherein the first substrate is a thin film transistor (TFT) substrate, and the second substrate is a color filter (CF) substrate;
assembling the first substrate and the second substrate as a large panel and curing the sealant there between;
applying a voltage and irradiating an ultraviolet light to the large panel, so as to allow LC molecules in the large panel to have a pre-tile angle; and
cutting the large panel according to a predetermined size, thereby achieving the LCD panel.

2. The method for manufacturing the LCD panel according to claim 1, characterized in that: the array process comprises:
arranging a plurality of gate lines with a specific interval and a plurality of data lines with a specific interval, wherein the gate lines are vertical to the data lines, and a minimum rectangular region, which is surrounded by the gate lines and the data lines, comprises a TFT and a pixel electrode; and
coating a black matrix, a color filter layer and a common electrode on the second substrate.

3. The method for manufacturing the LCD panel according to claim 1, characterized in that: one or two of three steps of coating the sealant, coating the silver adhesive and dispensing the LC mixed with monomers are executed on the first substrate by the production line, and the rest of the three steps is executed on the second substrate by the production line, and a sequence for alternately executing the three steps on the first substrate and the second substrate by means of the production line is arbitrary.

4. The method for manufacturing the LCD panel according to claim 1, characterized in that: the method further comprises:
after applying a voltage and irradiating an ultraviolet light to the large panel to allow the LC molecules in the large panel to have the pre-tile angle, irradiating the ultraviolet light to the large panel again, so as to allow the residual monomers of the LC molecules in the large panel to react completely.

5. The method for manufacturing the LCD panel according to claim 1, characterized in that: the step of cutting the large panel according to a predetermined size for achieving the LCD panel comprises:
bonding polarizers on an LC panel and pressing the LC panel to remove bubbles, thereby achieving the LCD panel.

6. An apparatus for manufacturing an LCD panel, characterized in that: the apparatus comprises:
a production line;
a production line control module configured to control the production line to alternately process a first substrate and a second substrate for achieving an array process of the first substrate and the second substrate, coating a sealant, coating a silver adhesive and dispensing an LC mixed with monomers, wherein the first substrate is a TFT substrate, and the second substrate is a CF substrate;
a substrate assembling module configured to assemble the first substrate and the second substrate as a large pane, and to cure the sealant there between;
an alignment control module configured to apply the voltage and irradiate the UV light to the large pane, so as to allow LC molecules in the large panel to have a pre-tile angle; and
a cutting module configured to cut the large panel according to a predetermined size, thereby achieving the LCD panel.

7. The apparatus for manufacturing the LCD panel according to claim 6, characterized in that: the production line comprises:
a substrate washing unit controlled by the production line control module, so as to wash the first substrate and the second substrate;
an alignment film coating unit controlled by the production line control module, so as to coat alignment films on the first substrate and the second substrate;
an alignment films curing unit controlled by the production line control module, so as to cure the alignment films on the first substrate and the second substrate;
a sealant coating unit controlled by the production line control module, so as to coat the sealant at the fringe of the first substrate or the second substrate;
a silver adhesive coating unit controlled by the production line control module, so as to dispense the silver adhesive on the first substrate or the second substrate; and
an LC dispensing unit controlled by the production line control module, so as to dispense the LC mixed with the monomers on the first substrate or the second substrate;
wherein the an arrangement sequence of the sealant coating unit, the silver adhesive coating unit and the LC dispensing unit on the production line is arbitrary.

8. The apparatus for manufacturing the LCD panel according to claim 6, characterized in that: the alignment control module comprises:
a voltage applying unit configured to apply a specific voltage to the large panel for adjusting the arrangement of the LC molecules in the large panel;
a curing unit configured to irradiate the ultraviolet rays to the large panel when voltage applying unit applies the voltage to the large panel, so as to allow the monomers mixed in the LC of the large panel to orient the LC molecules.

9. The apparatus for manufacturing the LCD panel according to claim 8, characterized in that: the curing unit is further configured to irradiate the ultraviolet rays to the large panel again, so as to allow the residual monomers to react completely.

10. The apparatus for manufacturing the LCD panel according to claim 9, characterized in that: the cutting module comprises:
an LC panel cutting unit configured to cut the large panel according to the predetermined size for forming an LC panel; and
a polarizer bonding unit configured to bond the polarizers to the LC panel and press the LC panel to remove bubbles, thereby achieving the LCD panel.
